(19) United States
(12) Patent Application Publication
(10) Pub. No.: US 2016/0092842 A1
(43) Pub. Date: Mar. 31, 2016

(54) Multiple-function planner and method of use

(71) Applicant: Bryan Wright, Richmond, VA (US)

(72) Inventor: Bryan Wright, Richmond, VA (US)

(21) Appl. No.: 14/863,129

(22) Filed: Sep. 23, 2015

Related U.S. Application Data
(63) Continuation of application No. 62/056,182, filed on Sep. 26, 2014.

(51) Int. Cl. G06Q 10/10

(52) U.S. Cl. CPC G06Q 10/1093

(57) ABSTRACT

This invention is directed toward a calendar that can be used to track time in both the traditional sense with sequential days, and in the project-planning sense allowing a user to track progress on one or more tasks that require more than a day to complete. The invention can be produced in both physical versions, such as paper or cardstock calendars, or projected onto a wall, or created through software programmed for this purpose. The software version would be customizable to each individual user's preferences. By presenting both the time-tracking and project-tracking aspects of the invention on a single item—whether it is a physical calendar or one on a computer—the user is benefited by the close proximity of the two functions, which are normally found on two entirely different items.

### CROSS REFERENCE TO RELATED APPLICATIONS

None

### STATEMENT REGARDING FEDERALLY SPONSORED RESEARCH OR DEVELOPMENT

This invention was not federally sponsored.

### BACKGROUND OF THE INVENTION

1. Field of the Invention

This invention relates to a calendar with multiple functions and a method of using the invention to track both the passage of time and to oversee and plan projects. Specifically, it is a calendar that allows for both the tracking of time, and the tracking of multi-day projects all on the same calendar. The theory behind this invention can be used with both physical calendars, screen-projected calendars, and software that allows a user to custom-create and tailor a calendar to his or her specific needs.

2. History of the Invention's Industry

Calendars have been used to track the passage of days for thousands of years. Calendars upon which someone can write notations to plan out a person's activities on particular days have been widely used for hundreds of years. These calendars serve very well to tell a person what he or she has planned for that day, but they are not very useful to keep track of a multi-day project that runs over a series of days. For example, while it may be easy to put down on consecutive days a series of actions that a person expects to take on a project, should the rate at which these tasks are done go faster or slower than expected, the future dates would have to be either moved forward or backward on the calendar. It is also useful to be able to separate out individual projects from the day-to-day activities that fill up most professional's calendars.

A better way to track multi-day projects is a flow charts e.g. a Gantt chart. A flow chart is a visual representation of a series of actions, or steps, that take place in a certain order. Flow charts have been used for around a century and are by far and away the most popular way to keep track of progress on a multi-day project. However, flow charts, including Gantt charts, are extremely poor tools for planning out a day or doing other time-sensitive planning for events that “have to happen”, no matter what the progress on a particular project may be at the time. For example, most Gantt charts are generally laid out as a linear series of a unit of time e.g. days or weeks and thus do not provide substantial structure or organization to aid the user in determining the relative position of a specific date within its respective week, month, or year. Thus, while Gantt charts are excellent tools for keeping track of where a person is on his or her project schedule, there is no corresponding calendar that provides a timeline of days, weeks, or other time units that the person can use to keep track of the passage of time. As such, the user of a flow chart must also keep a separate calendar to track the passage of time.

The result, however, is that many professionals currently use both a standard calendar and one or more flow charts to keep track of different aspects of their work and personal lives.

Thus there has existed a long-felt need for a single planning tool that contains means for both keeping tracks of days and daily activities and for tracking multi-day projects. This is difficult for several reasons. First, the user has to write notations on both the day- or hour-tracking portion and the flow chart, Gantt chart, or other project-tracking portion. This doubles the work the user has to do and leaves open the possibility that items will be missed on one or the other portion. Second, the user has to remember to bring both devices to meetings, business trips and other important events to truly be able to plan for the future. As with the previous weakness, by requiring the user to remember two different items, you are doubling the chance of failure due to forgetfulness. Third, even assuming the user has double-entered the same data on both portions, and remembered to bring both items, the user still has to visually scan between the two documents to figure out what is going on. Thus, a user relying on two separate documents would benefit from having these two documents combined into one.

The current invention provides just such a solution by having a calendar that combines the best aspects of a standard calendar with one or more flow charts. There are two basic sections to this calendar: a standard daily calendar and a lined section in which the user can track one or more multi-day projects. The advantages to the user are many. First, the user only has to remember one item for work, meetings, or travel. Second, it is much easier to plan out a daily schedule and synchronize it with project planning when both are on the same page, and the resulting organization will be superior that that which would have existed had the user had to use two separate items.

A third advantage is that because both the time-tracking and project-tracking sections represent any unit of time (from minutes, or even seconds, to months and years), the invention is (in the case of the software version) easily tailored to each user's needs, and in the pre-printed, or projected versions, easily made with respect to a variety of time units, such that a user can pick the correct one for his/her schedule. It is contemplated the a preferred embodiment of this invention would be a daily version, where the user could schedule events for each day in the time-tracking section, and follow the progress of projects from day to day on the project-tracking section. Another preferred embodiment would have time units of minutes and hours, such that a person could track progress of projects over the course of time units less than a day, even if the time-tracking portion was broken down into sub-units of hours or even minutes. For example, a short-term project that had many steps over the course of several days would be easier to track if the time units were hours.

The invention can be as simple as a standard calendar with a single open space above, below, to the side of, or superimposed on the standard calendar. The invention also envisions more complicated versions for more complex planning needs, including having the calendar portion laid out hourly, daily, and even with several months streamed together. The flow chart portion can have more than one line to allow a user to track more than one project over time.

The invention contemplates several different formats, including a paper or cardboard version that would fit on a desk or in a briefcase. This version would replace the standard wall or desk calendar/flow chart combination such that a user would need bring along only 1 item to meetings, travel, etc., upon which he/she could track both time and projects. Another contemplated version is having a hard copy, such as paper or cardboard, with a clean-erase cover over it, thereby allowing a user to more cleanly modify notations. It is also envisioned that a projector could be used to put an image up on a wall or screen, such that a number of people could comment or edit either or both of the day tracker and the project tracker. Finally, a software version of the invention could be installed on a computer, personal digital device, cell phone or other computational/storage device such that a user could personalize the invention to his or her needs.

In a particularly preferred embodiment, the time-tracking and project-tracking parts of the invention have the same width and that width represents the same unit of time. As mentioned previously, any time units could be used e.g. minutes, hours, weeks, months, years, but it is expected that hourly time units and daily time units will prove most useful to the broadest spectrum of businesspeople. It is also a preferred embodiment of the invention that a convenient time unit, such as one week, can be subdivided into the same unit e.g. days). So, in this way the two portions are in sync and the two sections visually relate to each other. The key to the synchronization is that the time-tracking portion runs vertically instead of horizontally like a traditional calendar.

### OBJECTS OF THE INVENTION

It is therefore an object of the present invention to provide a planning device that contains both a means to track the passage of days, hours, weeks, months, minutes or other time units, and to designate certain activities to take place on certain days, and a means by which multi-day or multi-time-unit projects can be tracked.

### STATEMENT OF THE INVENTION

Accordingly, one aspect the invention includes a standard calendar that tracks time on the order of hours or days, that can be arranged with a different unit of time on each page or impression, which the unit of time could be any unit including but not limited to hours, days, weeks, months, multiple months, or years.

A further aspect of the invention includes a means to track projects that extend beyond whatever unit of time was selected for the standard calendar. Thus, if the calendar is a weekly calendar with seven days laid out in sequential order, the means to track projects would extend over at least seven days.

Because the invention combines both a time-tracking function and a project-tracking function, it not only saves users from having to purchase, document, and keep track of two items, but also allows users to more effectively plan their schedules as they can see both the time-tracking and project-tracking functions one the same page or screen at the same time.

The invention is very flexible as well, depending on the needs of the user. For a retired person who has a few minor projects going on, but is mainly concerned with keeping track of his or her vacations, a daily calendar portion with a few lines for the various projects would probably suffice. For a much busier businessperson, a daily calendar further subdivided into ¼ hour units, with a larger number of open boxes to track projects would be more suitable. For the physical version paper version of this invention, different users can pick the appropriate version for them from the paper, cardboard, laminate, plastic or over versions. With a software version, it is contemplated that each user could personalize the calendar to his or her own needs.

There has thus been outlined, rather broadly the more important features of the combination of a time-tracking calendar and a project-tracking device in order that the detailed description thereof may be better understood, and in order that the present contribution to the art may be better appreciated. There are additional features of the invention that will be described hereinafter and which will form the subject matter of the claims appended hereto. Toward that end, one embodiment of the invention—a seven day calendar with note-taking capabilities—is presented below. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1A is a front view of a calendar according to a preferred form of the invention.

FIG. 1B is a close-up of the project-tracking portion of the calendar.

FIG. 1C is a close-up of the date-tracking portion of the calendar.

FIG. 2 is an end view of the calendar.

FIG. 3 is a side view of the calendar.

FIG. 4 is a back view of the calendar.

FIG. 5 is a front view of a multi-month version of the calendar.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

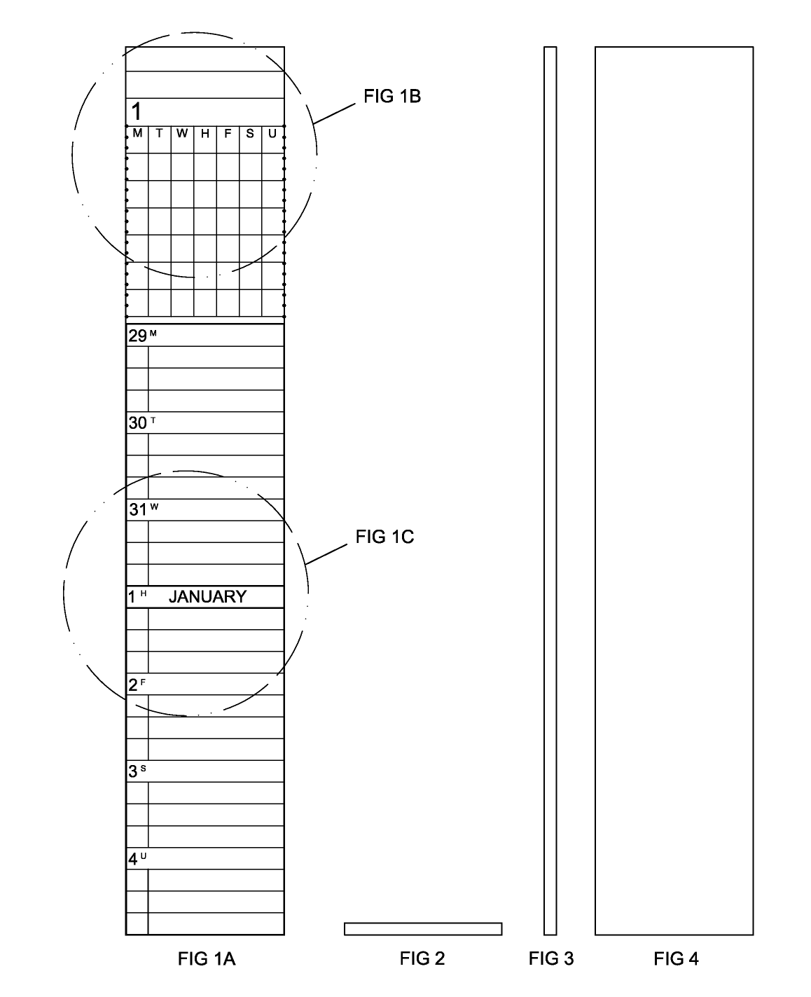

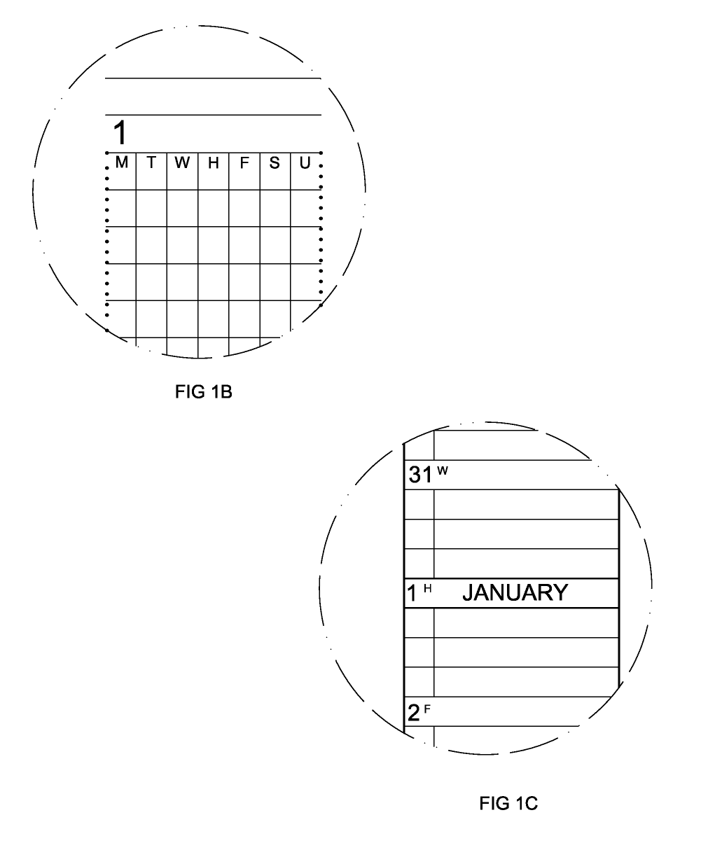

FIG. 1 FIG. 1A is a front view of a calendar according to a preferred form of the invention. In this embodiment, a seven day period of time is used to illustrate how the two parts of the calendar work together in one unit, so that users have to remember only one item to take to meetings or work. This figure also illustrates how the invention can make it easier to track projects and time by looking at both the passage of time and the progress of projects on a single calendar, and how both aspects of the invention are synchronized with each other.

FIG. 1B is a close-up of the project-tracking portion of the calendar.

FIG. 1C is a close-up of the date-tracking portion of the calendar.

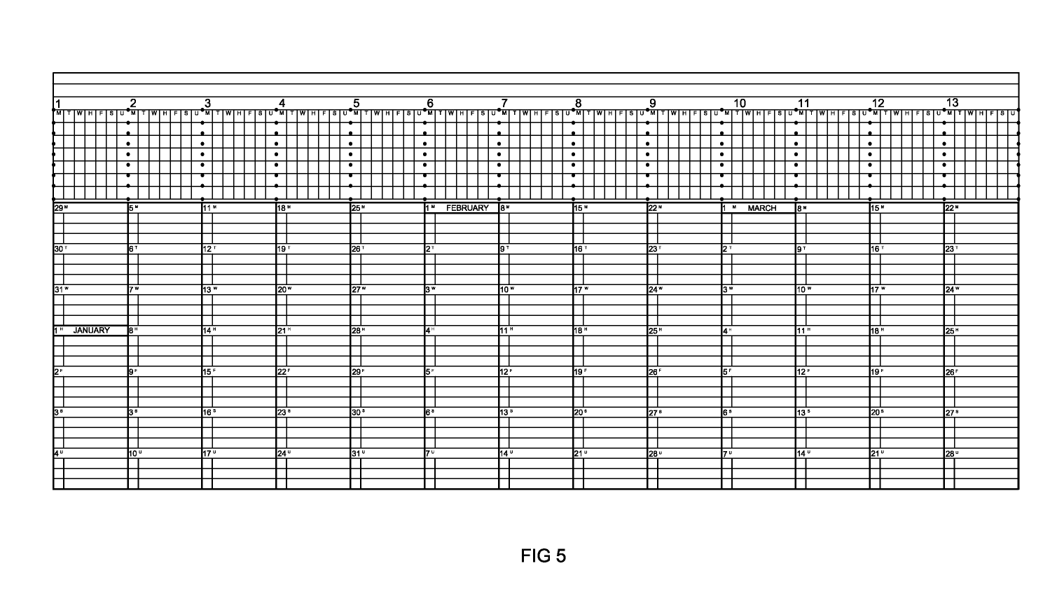

FIG. 2 is an end view and FIG. 3 is a side view of the calendar. It should be noted that these figures show a physical calendar, made out of thick paper or cardboard, but the invention also contemplates the use of the same theories and practices on software and wall projection devices, such that other versions of this invention will be two dimensional rather than three. It is also contemplated that a two dimensional version of the invention could be more easily custom-tailored to the user than a fixed, three-dimensional version. An addition to any of the versions could be the addition of a sheet of dry-erase film to the top of the invention. The sheet of dry-erase could have The addition of the dry-erase sheet will allow all of the embodiments of this invention to be displayed, and edited, on any surface that is desired, including but not limited to

[symbol]

FIG. 4 is a back view of the calendar. Again, it is contemplated that a physical, three-dimensional version is but one of the many possible iterations of this invention.

In one embodiment of the invention, as exemplified in FIG. 1, a 7-day daily planning device is described to help further explain the invention. It should be noted that this version of the invention is but one of many that is conceivable while still relying on the spirit of this invention.

In this embodiment, the layout uses different lines and symbols to form one component column representing a single calendar week. In this particular figure, the end of December and the beginning of January are portrayed, with spaces to write in important events on each day (FIG. 1C). Using lines of different colors, thicknesses, or the use of solid and dashed lines would be three ways to accomplish this goal. Multiple component columns of sequential weeks may be displayed side-by-side to display any number of weeks or infinite weeks, and depending on the amount of time that is desirable to display, this section can be enlarged pretty much indefinitely. It should also be noted that with the software version of the invention, each individual user can customize the “size” of each page of the invention to his or her tastes and needs. FIG. 5 is an illustration of this concept being stretched out to accommodate a quarterly planner.

The component column of the week in this particular version of the invention is divided horizontally into a note-taking area, or project-tracking portion, and a calendar area, or time unit-tracking portion. Either area may be displayed above the other. This way, the user does not need to divert his or her attention between two different devices to track both the passage of time and the progress of one or more projects, as opposed to the prior art which would require a user to bring two separate documents, and shift his attention between the two of them when trying to synchronize time- and project-tracking.

The note-taking area of the component column in this particular embodiment contains multiple rows and six vertical lines which form a grid for making notes in list, flow chart, or Gantt formats. In this particular figure, the days Monday through Sunday are laid out, such that a user can track up to six different projects at the same time (FIG. 1B)

The rows aid the user in making lists of tasks/notes that correspond to the particular week of the component column. Thus, the user can synchronize the functions of the two different sections, so that not only does he only have to remember to bring one “calendar”, but it is much easier to coordinate projects with the passage of time since both functions are right next to each other on the calendar.

The boxes of the grid can perform multiple functions. When listing tasks/notes, a box may be used as a status indicator such as a checkbox. It is contemplated that a checkbox could be included for each time unit when the invention is being produced. When making notes in Gantt format, the seven boxes formed by the six vertical lines in each row, may represent the seven days of the week. In versions of the invention with shorter or longer time units, the columns would represent longer or shorter time units. The user may highlight or otherwise join multiple boxes of a single row and label the group of boxes to represent a multi-day event. When multiple component columns of sequential weeks are displayed side-by-side, the user may even join groups of boxes that span more than one week.

The calendar area of the component column displays the dates that correspond to the particular week of the component column. For example, in FIG. 1A, there are several days in the vertical column (FIG. 1C) and a horizontal layout of Monday through Sunday in the upper portion (FIG. 1B). The calendar area is divided horizontally into seven sections representing each day of the week. The first and topmost section represents the first day of the week, the second section represents the second day of the week, and so on until the seventh and bottommost rectangle represents the last day of the week. Each section representing a specific date may contain labels indicating the day of the week, date of the month, day of the year, holidays, lines for notes, or status indicators such as checkboxes. By combining and synchronizing the day-tracking and project-tracking components of this invention, the user is benefited in several ways. First, as mentioned earlier, he does not have to remember to bring two separate calendars to work and meetings. Second, there is less likelihood of error as the user is not as likely to record an event on one calendar and forget to do it on another. Third, because the user need only move his eyes up from the day-tracking portion to the project-tracking portion, he is more likely to manage time and projects better as both appear simultaneously on the page. Fourth, because the sizes of the columns are the same for both the time-tracking and project-tracking aspects of the invention, they are synchronized for the user, thereby making the invention more productive than would be two separate items.

FIG. 5 is a front view of a multi-month version of the calendar. This figure shows how the invention can be used over a longer time period to accomplish the same purpose: namely, allowing the user to keep track of certain things to do on certain days and at the same time track a project that is expected to take a longer period of time. The bottom section of FIG. 5 shows the day-tracking section, which looks very much like one version of a standard calendar. The upper section has space to track seven different projects simultaneously, as well as three lines at the top of the page for flow charts or other project-tracking writings.

The presentation of time flows intuitively horizontally in single-week units. Vertically oriented days of the week in the calendar area offer more intuitive display of daily events, because events displayed on the second day naturally follow below those displayed on the first day of the week, the events of the third day follow below those of the second, and so on. In this way, the entire week of events presents as a cohesive list of events that proceed sequentially from top to bottom like a task list.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device for tracking both time and one or more projects, comprising a time-tracking portion and a project-tracking portion.

2. The device of claim 1, where, the time-tracking portion is divided into units of time, where the units of time are selected from the group comprising hours, days, weeks, and years.

3. The device of claim 2, where the project-tracking portion comprises one or more lines, delineating an open space relating to at least one of the units of time, and where the time-tracking section and the project-tracking sections have the same horizontal width, thereby allowing the two parts to represent the same unit of time such that the time-tracking section and the project-tracking section are in sync and the two sections visually relate to each other.

4. The device of claim 3, where the project-tracking portion is a flow chart.

5. The device of claim 3, where the project-tracking portion is a Gantt chart.

6. The device of claim 1, where the project-tracking portion is located above the time-tracking portion.

7. The device of claim 1, where the project-tracking portion is located below to time-tracking portion.

8. The device of claim 1, where the project-tracking portion is located to the side of the time-tracking portion.

9. The device of claim 1, where the project-tracking portion is located superimposed on the time-tracking portion.

10. The device of claim 1, where the device is printed onto a piece of paper or some other object capable of being picked up and carried with the user

11. The device of claim 1, where the device is printed onto paper, plastic, cardboard or some other substance suitable for mounting on a wall or other reasonably flat structure.

12. The device of claim 1, additionally comprising a dry-erase page, with means for adhering the dry-erase page to the device, such that a user can edit notes made on the device.

13. The device of claim 1, where the device is created with software and can be downloaded and installed on an electronic device such as a computer, personal digital assistant, or cell phone.

14. The device of claim 1, where the device is projected onto a wall or other relatively flat surface through use of a projector or other light-emitting device.

15. The device of claim 1, where the lines delineating different sections are not uniform in one of more of: thickness, color, solid v. dashed.

16. A method of keeping accurate records of both dates/events, and projects/progress, comprising the steps of acquiring a device that is capable of hosting both a time-tracking portion and a project-tracking portion on a single device.

17. The method of claim 16, where, the time-tracking portion is divided into units of time, where the units of time are selected from the group comprising hours, days, weeks, and years.

18. The method of claim 17, where the project-tracking portion comprises one or more lines, delineating an open space relating to at least one of the units of time, and where the time-tracking section and the project-trackings have the same horizontal width, thereby allowing the two parts to represent the same unit of time such that the time-tracking section and the project-tracking section are in sync and the two sections visually relate to each other.

19. The method of claim 17, where the project-tracking portion is a flow chart.

20. The method of claim 16, where the project-tracking portion is a Gantt chart.

21. The method of claim 20, where the project-tracking portion is located above the time-tracking portion.

22. The method of claim 20, where the project-tracking portion is located below to time-tracking portion.

23. The method of claim 20, where the project-tracking portion is located to the side of the time-tracking portion.

24. The method of claim 20, where the project-tracking portion is located superimposed on the time-tracking portion.

25. The method of claim 18, where the device is printed onto a piece of paper or some other object capable of being picked up and carried with the user.

26. The method of claim 18, where the device is printed onto paper, plastic, cardboard or some other substance suitable for mounting on a wall or other reasonably flat structure.

27. The method of claim 18, additionally comprising a dry-erase page, with means for adhering the dry-erase page to the device, such that a user can edit notes made on the device.

28. The method of claim 18, where the device is created with software and can be downloaded and installed on an electronic device such as a computer, personal digital assistant, or cell phone.

29. The method of claim 18, where the device is projected onto a wall or other reasonably flat surface through use of a projector or other light-emitting device.

30. The method of claim 18, where the lines delineating different sections are not uniform in one of more of: thickness, color, solid v. dashed.
